(19) United States
(12) Patent Application Publication
(10) Pub. No.: US 2009/0065324 A1
(43) Pub. Date: Mar. 12, 2009

(54) Gaming Token And Method For Its Use

(75) Inventors: Noah Axler, Maple Glen, PA (US); Sasha L. Azar, Bryn Mawr, PA (US)

Correspondence Address: LEE & HAYES, PLLC, 601 W. RIVERSIDE AVENUE, SUITE 1400, SPOKANE, WA, 99201, US

(73) Assignee: Noasha LLC, Maple Glen, PA (US)

(21) Appl. No.: 12/205,669

(22) Filed: Sep. 5, 2008

Related U.S. Application Data
(60) Provisional application No. 60/970,502, filed on Sep. 6, 2007.

(51) Int. Cl. A63F 9/24; G07F 7/00

(52) U.S. Cl. 194/205; 463/25

(57) ABSTRACT

Disclosed herein are techniques for the creation, distribution and use of a token that is used in a gaming system.

### RELATED APPLICATIONS

This application claims the benefit under 35 USC 119(e) to U.S. Provisional Application Ser. No. 60/970,502 filed on Sep. 6, 2007 entitled “Gaming Token And Method For Its Use” by first named inventor Noah Axler.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 shows an exemplary implementation of a gaming system.

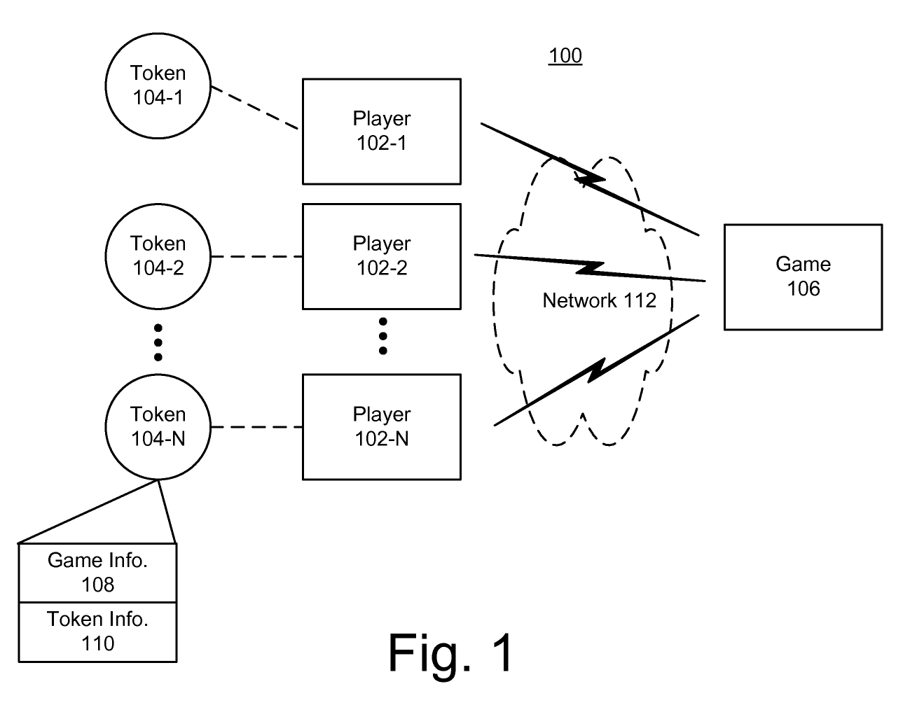

FIG. 2 shows an exemplary implementation of a gaming token in the form of a marble.

FIG. 3 shows an exemplary implementation of a game.

FIG. 4 shows an exemplary implementation of a process of utilizing a gaming token in a gaming environment.

### DETAILED DESCRIPTION

Disclosed herein are techniques for the creation, distribution and use of a token that is used in a gaming system. In one described implementation, a gaming token is provided that contains information, which the player may use with game. The token may allow the player to enter the game or may give the player certain characteristics, attributes, functions, or other capabilities while the player is interacting with the game or with other players or other entities related to the game.

According to another implementation, a method is provided for using a gaming token within a game. The player may obtain the token by purchase or trade. The player may utilize information associated with the gaming token to enter one or more games or to obtain certain characteristics, attributes, functions, or other capabilities while the player is interacting with the game, with other players of the game, or with any other entity related to the game.

The techniques described herein may be implemented in a number of ways. One example environment and context is provided below with reference to the included figures and on going discussion.

Exemplary Systems

According to one implementation, a gaming system 100 is provided in which one or more players 102 obtain and use one or more gaming tokens 104 in the context of a game 106. The dashed line between the token 104 and the player 102 represents the player 102 having access to that token 104. The game 106 may implemented in a computing environment and may be stored as a set of instructions on one or more computer readable media. Each token 104 may include game information 108 that is specific to the game, the game administrator, the token distributor, or the token manufacturer. Each token 104 may additionally or alternatively include token specific information 110, which may indicate and/or determine characteristics, attributes, functions, or other capabilities that will be available to the player during engagement with the game 106. The one or more players may interact with the game and/or with each other via a wired or wireless network 112, such as the internet.

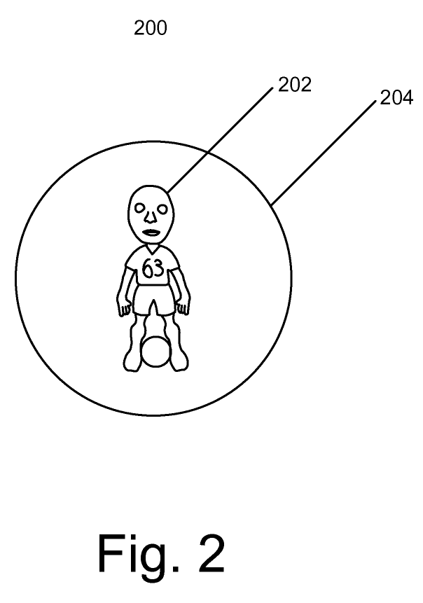

FIG. 2 illustrates one implementation of a token 200 for use in a gaming environment such as gaming system 100. The token 100 may be spherical, as shown. Alternatively, the token 100 may be semi-spherical, square, rectangular, egg-shaped, tubular, cylindrical, or other suitable shape. The token may be made of glass, stone, plastic, wood, or other material. Each token 100 may be provided in one or more colors. The token may be clear or opaque.

As shown in FIG. 2, an image 202, or other visual or tactile cue, is provided on or with in the token 204. The image 202 may be white or other suitable color and may have two-dimensional and/or three-dimensional characteristics. For example, the image 202 may be that of a character in the game and may be etched as a three dimensional image within a glass marble token 204. The image may be formed on or within the token using laser etching, chemical etching, or other suitable technique. The image may have educational aspects, such as one or more number and letters designed for educational purposes. Such an educational image may be used for a game that has at least one educational aspect.

The image 200 may provide information about the game and/or about the token 204. For example, the image may include game information, such as a character name and/or likeness, game titles, and/or graphics or other game-related information 108. The image may also include token information 110, which may be unique to each token, such as a multi-digit alphanumeric or other code that may be used in the interaction with the game, the other players of the game, or other entity associated with the game.

The token information may provide access to the game or may provide information used to access the game. For example, if the game is a web-enabled game, the player may enter the token information, e.g. code numbers and/or letters, into a player interface in order to enter and/or interact with the game, players of the game, or other entity associated with the game.

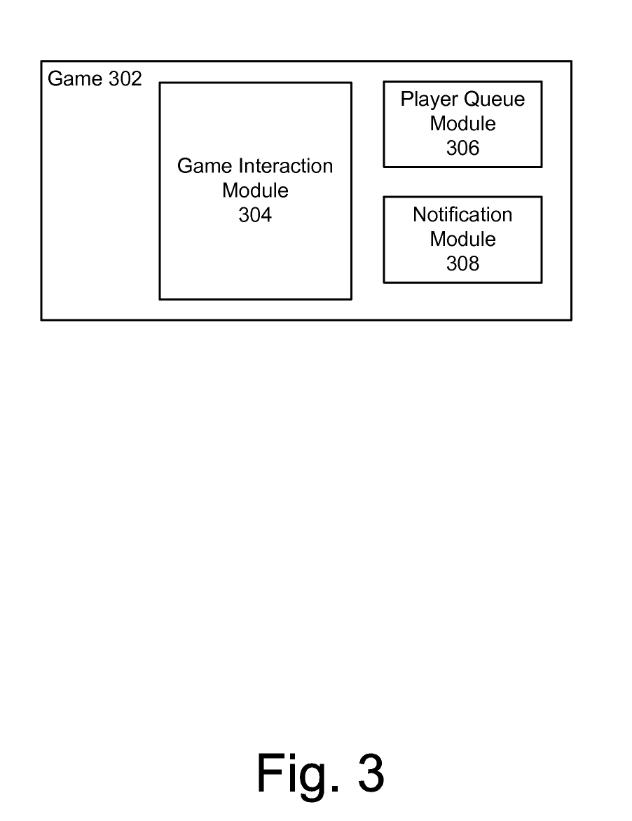

FIG. 3 shows one implementation of a game 302, which may be implemented as software stored on one or more computer readable storage media. The game 302 has a game interaction module 304 in which one or more players interact with the game 302. According to one example, the game interaction module may include a battle scenario in which a player interacts with the game interaction module 304 as a monster character and battles other player implemented or software-program implemented monster characters. According to this example, the battle scenario may include fifteen (15) characters constantly doing battle. The player registers by entering token information provided with the gaming token. The player is then entered into a queue associated with a player queue module 306. The consumer provides notification information, such as an email address, which is stored in a notification module 308. The notification module 308 notifies the player of that player's place in the queue and when that player is next in the queue to enter the gaming interaction module 304. The player enters and exits the queue in a first in-first out manner. As a character in the battle scenario is eliminated in the game interaction module 304, a new character associated with the next player in the player queue module 306 is notified through notification module 308 that the character is enabled within the game interaction module 304. The player may interact with the game interaction module 304 for some fixed or variable period of time or based on other criteria, such as may be provided on the token, e.g., token 104. Further aspects of the method of utilizing a token within a gaming environment will be described below

Although a gaming environments, tokens, and games are described above, this implementations are meant to serve only as a non-limiting examples.

Exemplary Process

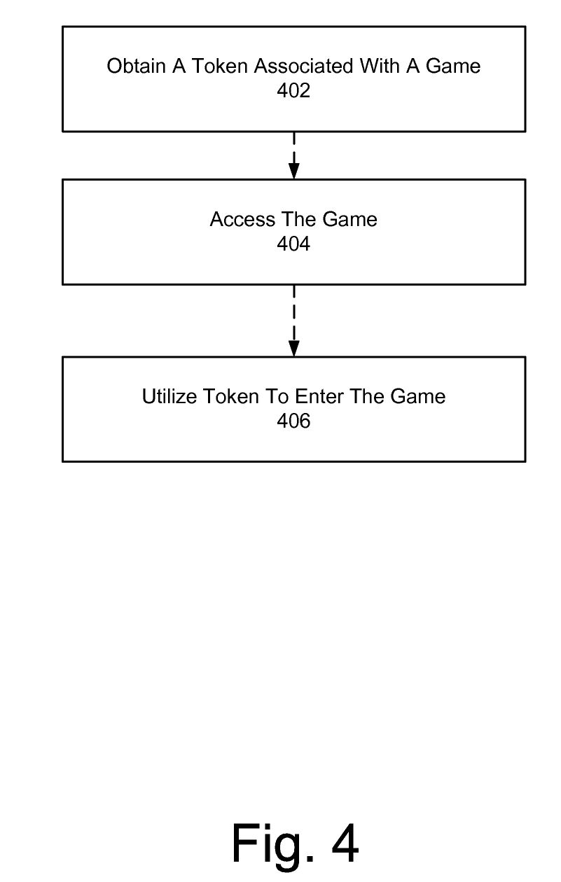

FIG. 4 shows one example implementation of a process 400 for utilizing a token within a gaming environment.

At block 402, a player obtains a token associated with a game. The player may obtain the token by purchase or trade from a manufacturer, retailer, or other entity. The token may include game and/or token information.

At block 404, a player accesses the game. The game may be a software-enabled game and may be accessed by the player using a computing device. The game may be stored locally on the computer or stored in a location remote from the computer and accessed by the computer via a network, such as the internet.

At block 406, the player uses the token to enter the game. The player may enter token information, e.g. token information 110, to enter the game. For example, if the token is provided with an alphanumeric code, the user may enter the code through user interface to enter the queue or the game directly. The act of entering the game may include directly entering a game interaction module or being stored on a player queue module as described above with reference to FIG. 3.

As a more particular example, a player enters the game through a registration process. As part of the registration process, the player provides token information as well as an email address. The player is placed in a queue in which the first player in the queue replaces a player that has been eliminated from the game. As one player is eliminated from the game, the next player in the queue enters the game as a character in the game, and so forth. Each player is notified that the character is available for use in the game using the notification information provided by that user. The player may then have a limited time, for example one hour, to access the game and to interact with the game consistent with the token and/or the character. The player, as the character, interacts with the other characters within the game as long as a power supply on that character remains. The power supply may be dependent time or other factors, such as obtaining certain goals or through unsuccessful engagement with the other characters. In the battle scenario example, the character may lose power when other characters have successfully attacked. Once the power supply on that character disappears the player is eliminated from the game and that character is immediately taken over by new character associated with a different token and/or player who is the next in queue.

Although the above methods are shown as exemplary implementations, these implementations are meant to serve only as non-limiting examples.

Specifics of exemplary methods have been described. However, it should be understood that certain acts need not be performed in the order described, and may be modified, and/or may be omitted entirely, depending on the circumstances. Moreover, the acts described may be implemented by a computer, processor or other computing device based on instructions stored on one or more computer-readable media. The computer-readable media can be any available media that can be accessed by a computing device to implement the instructions and/or other data stored thereon.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims.

1. A gaming system comprising:
a game; and
a token associated with the game, the token including: a marble, an image associated with the marble, and information specific to the marble to be used by a player of the game to enter the game or to provide the player with specific characteristics based on the information once in the game.

2. A gaming system according to claim 1, wherein the game is a software-enabled game.

3. A method comprising:
obtaining a token associated with a game, the token having information unique to the token;
accessing the game; and
utilizing information associated with the token to enter the game.

4. A method according to claim 1, wherein accessing the game is performed using a computing device.

5. In a gaming environment, a token comprising
a marble;
a visual or tactile cue associated with the marble;
information pertaining to a game and specific to the token.
